(19) United States
(12) Patent Application Publication
(10) Pub. No.: US 2004/0170087 A1
(43) Pub. Date: Sep. 2, 2004

(54) Electronic device and method of assembling electronic device

(76) Inventor: Ikue Shimizu, Chiba-shi (JP)

Correspondence Address: ADAMS & WILKS, 31st Floor, 50 Broadway, New York, NY, 10004, US

(21) Appl. No.: 10/775,808

(22) Filed: Feb. 10, 2004

(30) Foreign Application Priority Data
Feb. 19, 2003 (JP) 2003-041498

(51) Int. Cl. G04B 47/00

(52) U.S. Cl. 368/10

(57) ABSTRACT

An object is to provide an electronic device and a method of assembling electronic devices, in which a wiring member can be prevented from twisting and the reliability and efficiency of work can be improved. A twist protection function is provided to a wiring member, which is connected to a curved liquid crystal display panel at one end, and folded to be received in a casing. Such a twist protection function can be fulfilled by forming a connector portion of a circuit block into a roughly V-like shape, to which the wiring member is connected with bending in roughly V-like shape, or by thermally deforming the wiring member on the side of the curved liquid crystal display panel.

### BACKGROUND OF THE INVENTION

1. Field of the Invention

The present invention relates to various kinds of electronic devices including wristwatch, and to a method of assembling electronic devices.

2. Description of the Prior Art

Hitherto, in electronic devices including wristwatch, when a display unit having a liquid crystal display panel is used, this liquid crystal display panel is generally planar and its display unit is also generally covered by a planar glass plate.

Contrary to that, in recent years, the display unit, in which its liquid crystal display panel is curved and its glass plate is also curved, has appeared.

FIG. 9 shows a schematic structure of such a wristwatch 1, and, as can be seen in this FIG. 9, the wristwatch 1 includes in a casing 2 a liquid crystal display panel 3 that displays information of the time etc. and a circuit block 4 that controls this liquid crystal display panel 3.

The liquid crystal display panel 3 is film-shaped and provided with an EL (Electro luminescence) panel, not shown, on its rear side. Those liquid crystal display panel 3 and the EL panel (not shown) have been curved by interposing those panels between a lower panel frame 5 and an upper panel frame 6, both of which having been molded into predetermined curved shapes.

The circuit block 4 is composed of IC(integrated circuit) and other devices, which are mounted on a circuit board, and is supported on a circuit mount plate 7.

Furthermore, the lower panel frame 5, which supports the liquid crystal display panel 3 and the EL panel (not shown), the upper panel frame 6 and the circuit mount plate 7 supporting the circuit block 4 are integrally held by a module fixing plate 8, and those components form a movement 9 of the wristwatch 1.

Such a movement 9 is received in an opening portion 10 formed in the casing. 2, and the liquid crystal panel 3 of the movement 9 is disposed in such a manner that its display portion can be exposed through a glass plate 11 covering the opening portion 10.

According to such a wristwatch 1 etc., since the glass plate 11 is formed into a curved shape, it is characterized in that an unusual design can be provided, and that the display area in the liquid crystal display panel 3 can be made lager-sized (e.g. see JP-A-2002-250907 (Paragraphs 0012-0019 and FIG. 1)).

Incidentally, in wristwatches 1 as shown in FIG. 9, there is a problem that a twist 100 occurs in a wiring member 12 that connects the liquid crystal display panel 3 and the circuit block 4.

Namely, in such a wiring member 12, a predetermined wiring pattern is formed and a belt-shaped printed circuit board having a width corresponding to the number of the predetermined wirings is employed. When the liquid crystal display panel 3 is curved as described above, the wiring member 12 is also inevitably curved in a manner that its section describes roughly a circular arc at a portion 12a connected to the liquid crystal display panel 3.

Such a wiring member 12 is connected to the liquid crystal display panel 3 and the circuit block 4 through a member called heat seal connector. The heat seal connector has the structure, in which a wiring pattern composed of conductive materials is formed on a polyester film and coated with an insulating thermally-fusible resin. Such heat seal connectors have been welded to both ends of the wiring member 12 in advance. In the mounting process of the wiring member 12, the end portions of the heat seal connector are positioned at respective predetermined positions of the liquid crystal display panel 3 and the circuit block 4, and then the end portions are thermally compressed with a heater. This makes the thermally-fusible resin fuse to expose the wiring pattern, and thereby the wirings of the liquid crystal display panel 3 and the circuit block 4 are connected with the wirings of the heat seal connectors, which are formed on both ends of the wiring member 12.

Now, if the wiring member 12 is connected to the curved liquid crystal display panel 3, a twist 100 could be generated in the wiring member 12 because the portion 12a is curved in a circular arc.

Moreover, at such a portion, a stress could be concentrated also to the heat seal portion (connected portion) of the wiring member 12 and the liquid crystal display panel 3, and it could lead to the connection failure etc. of the wiring member 12.

In addition to those, there are problems that, when the wiring member 12 is connected to the curved liquid crystal display panel 3, their positioning, fixing, etc. are very troublesome work as compared with the almost linearly connected portion, and thereby the work is of a poor efficiency and the process has a high risk to produce defects, and so forth.

Furthermore, after the connection of the wiring member 12 to the liquid crystal display panel 3 and the circuit block 4, the belt-shaped wiring member 12 must be folded and received into the opening portion 10 of the casing 2. If a twist 100 has been generated in the wiring member 12 in that case, its folding ability will be lowered and a stress concentration is ready to occur at the portion connected to the liquid crystal display panel 3 and the circuit block 4.

### SUMMARY OF THE INVENTION

The present invention has been made in view of such technical problems. Accordingly, an object of the present invention is to provide an electronic device and a method of assembling electronic devices, in which a wiring member can be prevented from twisting and the reliability and efficiency of work can be improved.

For such an object, an electronic device according to the present invention comprises two substrates laminated vertically and a belt-shaped wiring member having flexibility, for connecting electrically the two substrates, wherein at least one of two substrates is curved. Moreover, it is characterized in that it comprises a stress relaxation portion for easing a stress, which works on the wiring member by a connection between the wiring member and the substrate having a curved shape.

According to such a wiring member, the stress can be eased by the stress relaxation portion, and thereby the occurrence of twist etc. in the wiring member can be suppressed.

Moreover, when the stress is eased by the stress relaxation portion, a stress generated at a portion of the wiring member connected to the substrate can be also eased.

As a stress relaxation portion, a configuration, in which, on one of the substrates, a connector portion is formed in a bent-shape or curved-shape on the substrate, and the wiring member is connected in a bent or curved manner correspondingly to the bent-shape or curved-shape of the connector portion, may be employed. In this case, the connector portion may be also formed into a bent or curved shape corresponding to the curved shape of the substrate.

As a further stress relaxation portion, additionally, the belt-shaped wiring member may be also provided with a deformed portion, which is curved toward such a direction that the stress, which works on the wiring member, can be eased. In order to form such a deformed portion, various deformation processes such as thermal-deformation by heating the wiring member or pressure-deformation with a press can be considered. By forming such a deformed portion, it is possible to form the wiring member into a solid three-dimensional shape, instead of a simple belt-shape.

Furthermore, the configuration of the two substrates is not limited to direct lamination, but the other substrate or part may be interposed, as far as the two substrates are in laminated relationship.

Another aspect of the present invention is an electronic device having a display unit that is curved in a three-dimensional shape. In such an electronic device, a display panel that composes a display unit is curved, and a panel-shaped circuit block that controls the display panel and the display panel are received in a casing forming an outer shell. Moreover, a belt-shaped wiring member is connected to the display panel and the circuit block at both end portions by heat sealing or other methods under the condition that an intermediate portion of the wiring member is folded back in the casing, and connects electrically both the display panel and the circuit block. Furthermore, it is configured so that a flexure that is generated in the wiring member by a connection between the wiring member and a curved part of the display panel can be absorbed by the flexure absorbing portion.

Such an electronic device is suitable for composing a watch, in which a three-dimensional display cover is mounted on an opening portion of a casing, under the condition that the circuit block and the display panel are contained in the casing having an opening on the display unit side and a closed bottom. Of course, it is needless to say that the present invention can be applied to various electronic devices other than watch.

As the flexure absorbing portion, the wiring member may be provided with a substantially spherically curved portion. Such a curved portion can be formed by heating the wiring member and making it thermally-deformed, or by pressure-deforming with a press.

In this connection, the place the flexure absorbing portion is formed is not limited to the wiring member itself, but the flexure absorbing portion may be formed anywhere else as far as it can absorb the flexure.

Besides, as the stress relaxation portion or the flexure absorbing portion, structures allowing the wiring member to be easily deformed outward from a plane, by forming the end of the wiring member into a shape corresponding to the curved substrate, or by forming the wiring member into a net-shape or an accordion-shape, may be also employed.

Moreover, it is also effective to divide the end of wiring member facing the curved substrate into a plurality of parts, or to form it into a shape corresponding to the curved substrate. Furthermore, it is also effective to bend obliquely halfway the wiring member.

The term “flexure” used here is not the flexure generated when an intermediate portion of the wiring member is folded back in the casing, as mentioned before, but is the local flexure generated in the wiring member when an end of the wiring member is connected to the curved display panel. That is, in contrast to the continuous flexure generated in the wiring member folded back in the casing, the object to be absorbed is the flexure that is discrete. In order to specify such a flexure absorbing portion, you have only to compare the state of flexure occurrence with the case when the display panel is connected to the circuit block through a simple belt-shaped wiring member as in the prior art. If the local flexure has been reduced by forming the above-described curved portion etc., compared with the case of simple belt-shaped wiring member, then it is fulfilling the function as a flexure absorbing portion.

Still another aspect of the present invention is a method of assembling an electronic device, which has a planar first circuit panel and a curved second circuit panel, and it is characterized in that the method comprises steps of connecting an end of a belt-shaped wiring member to the first circuit panel, heating the wiring member to curvedly deform another end portion of the wiring member, and connecting the another end of the wiring member to the second circuit panel. In this case, the step-of curvedly deforming the wiring member is preferably carried out at the preceding stage before the step of connecting the another end of the wiring member to the second circuit panel. However, it is a matter of course that the step of curvedly deforming the wiring member may be carried out in the latter stage, i.e. after the steps of connecting both ends of the wiring member to the first and second circuit panels.

Furthermore, in the step of curvedly deforming the wiring member, the position to be heated is described as “another end portion” of the wiring member, instead of “another end”, and it is intended that the position to be heated should not be limited to the “another end” but it includes also “the vicinity of another end”.

### BRIEF DESCRIPTION OF THE SEVERAL VIEWS OF THE DRAWINGS

A preferred form of the present invention is illustrated in the accompanying drawings in which:

FIG. 1 is a perspective divided diagram showing the entire structure of watch according to a mode for carrying out the invention;

FIGS. 2A-2B are perspective views showing an example of the structure, in which a wiring member is folded when connected to a circuit block;

FIG. 3 are perspective views showing an example, in which a wiring member is heated to curve;

FIG. 4 is a perspective view showing an example, in which a wiring member is formed into an accordion-shape;

FIG. 5 is a perspective view showing an example, in which a wiring member is bent at its intermediate portion to curve;

FIG. 6 is a perspective view showing an example, in which a wiring member is formed into a net-shape;

FIG. 7 is a perspective view showing an example, in which an end portion of the wiring member is divided;

FIGS. 8A-8B are perspective views showing an example, in which an end portion of the wiring member is formed into a curved-shape to be curvedly connected to a liquid crystal display panel; and

FIG. 9 is a perspective divided diagram showing the entire structure of watch in the prior art.

### DETAILED DESCRIPTION OF THE PREFERRED EMBODIMENTS

Hereinafter, this invention will be described in detail based on the mode for carrying out, which is shown in the attached drawings.

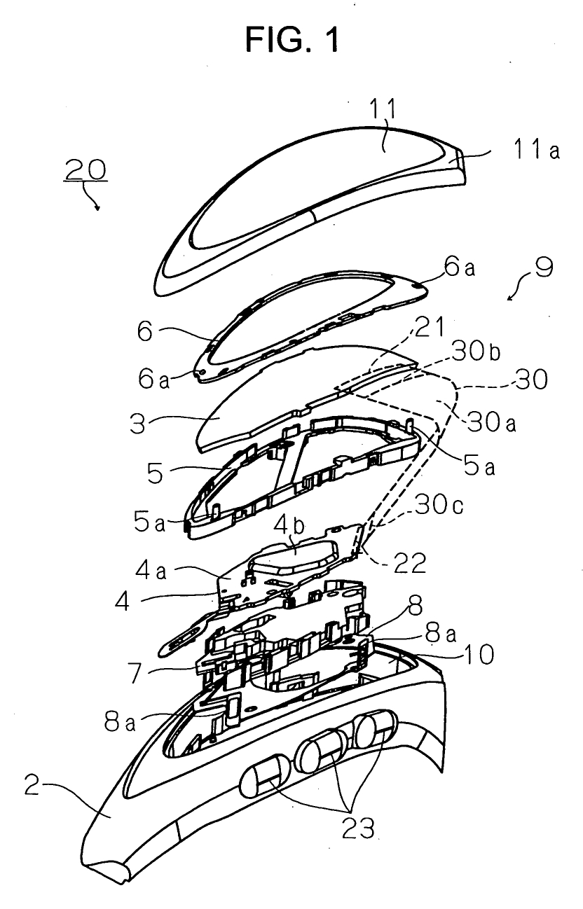

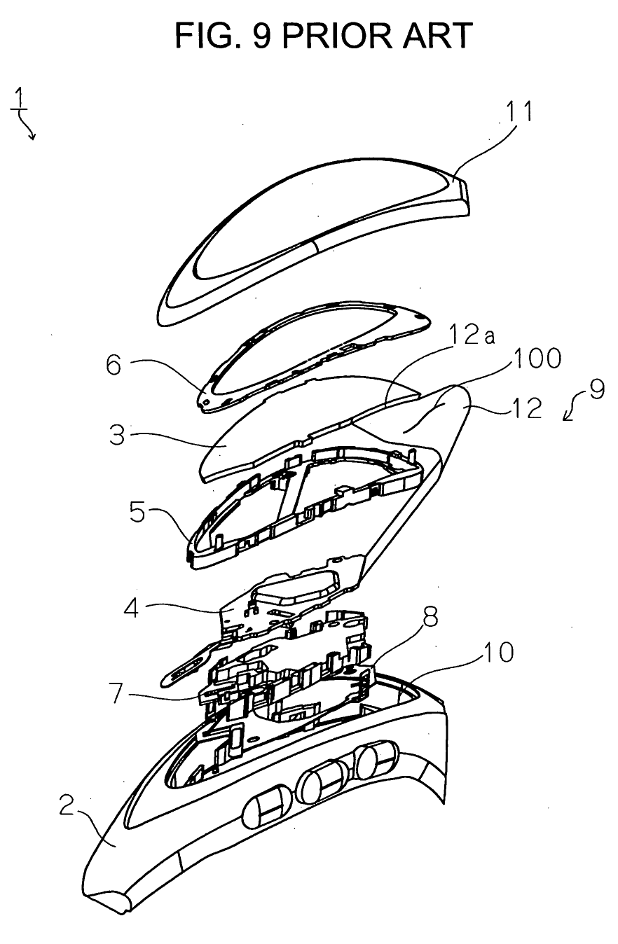

FIG. 1 shows a schematic structure of the wristwatch 20 in the mode for carrying out the invention. In this figure, with respect to the components common with the conventional wristwatch 1 as shown in FIG. 9 the same symbols are attached.

As shown in this FIG. 1, the wristwatch 20 is provided with, in a casing 2, a liquid crystal display panel 3 (a substrate, a display unit, display panel and a second circuit panel) that displays information of the time etc., and a circuit block 4 that controls this liquid crystal display panel 3.

The liquid crystal display panel 3 is made of polyester material etc. and film-shaped, and has a softness (flexibility) at least to such a degree that it can be curved. On the rear side of the liquid crystal display panel 3, an EL panel, not shown, that irradiates an illumination light from the rear side toward the liquid crystal display panel 3, is provided. On such a liquid crystal display panel 3, a connector portion 21 with each wiring electrode of the wiring pattern exposed is formed on the predetermined peripheral positions, for electrically communicating with the circuit block 4.

Those liquid crystal display panel 3 and the EL panel (not shown) are interposed between a lower panel frame 5 and an upper panel frame 6, both of which having respective openings at their central portions. On the top surface side of the lower panel frame 5, a plurality of projections for curving the liquid crystal display panel 3 and a curved plane portion have been formed. On the other hand, the upper panel frame 6 has been molded into a predetermined curved-shape. Those lower panel frame 5 and upper panel frame 6 are provided with pins 5a and holes 6a, which can be engaged with each other, at several positions, and, by the engagement between the pins 5a and the holes 6a, the liquid crystal display panel 3 can be held at its periphery and kept in the predetermined curved shape.

The circuit block 4 is composed of the elements such as IC 4b and other devices, which are mounted on a panel-shaped circuit board (a substrate and a first circuit panel) 4a, and, on the predetermined peripheral positions, a connector portion 22 with each wiring electrode of the wiring pattern exposed is formed, for electrically communicating with the liquid crystal display panel 3. Such a circuit block 4 is supported on a circuit mount plate 7.

Furthermore, the lower panel frame 5, which supports the liquid crystal display panel 3 and the EL panel (not shown), the upper panel frame 6 and the circuit mount plate 7 supporting the circuit block 4 are integrally held in a laminated structure, and that is achieved by securing the tip ends of securing nails 8a formed on a module fixing plate 8 to the lower panel frame 5. Thus integrally laminated unit, which has been composed of the lower panel frame 5, the liquid crystal display panel 3, the EL panel (not shown), the upper panel frame 6, the circuit block 4, the circuit mount plate 7 and the module fixing plate 8, forms a movement 9 of the wristwatch 20.

Such a movement 9 is received in an opening portion with a closed bottom 10 formed on the surface side of the casing 2.

On the opening portion 10 of the casing 2, a three-dimensional glass plate (display cover) 11 having an ornamental frame 11a is mounted, and the glass plate 11 covers the liquid crystal display panel 3 in the movement 9, in such a manner that its display portion can be exposed through, the glass plate 11. Those components form a display unit that displays information of the time etc.

In FIG. 1, the symbol 23 stands for operation buttons formed on the side of the casing 2.

Here, in the wristwatch 20 as described above, the connector portion 21 of the liquid crystal display panel 3 and the connector portion 22 of the circuit block 4 are belt-shaped as a whole, and electrically connected to each other through a wiring member 30 having a twist protecting function, for carrying out the power supply, the control signal transmission, etc. to the liquid crystal display panel 3.

Such a wiring member 30 is belt-shaped as a whole, its body portion 30a being a so-called flexible PCB (Printed Circuit Board) having a flexibility, and heat seal connectors 30b, 30c have been provided on both end portions of the wiring member 30 in advance. The wiring member 30 is connected to the liquid crystal display panel 3 and the circuit block 4 through the heat seal connectors 30b, 30c of both end portions. The wiring member referred to as wiring member 30 in the description hereinafter will be intended to be basically the wiring member having the heat seal connectors 30b, 30c integrally formed on its both end portions.

The heat seal connectors 30b, 30c have a function for connecting in one-to-one relationship between each wiring of the wiring member 30 and each wiring (wiring electrode) of the connector portions 21, 22 of the liquid crystal display panel 3 and the circuit block 4. The heat seal connectors 30b, 30c have the structure, in each of which a wiring pattern composed of conductive materials is formed on a polyester film and the wiring pattern is further coated with an insulating thermally-fusible resin. Those heat seal connectors 30b, 30c have been welded to both end portions of the wiring member 30 in advance. In the mounting process of the wiring member 30, the end portions of the heat seal connectors 30b, 30c are positioned at respective predetermined positions of the liquid crystal display panel 3 and the circuit block 4, and then the end portions are thermally compressed with a heater. This makes the thermally-fusible resin fuse to expose the wiring pattern, and thereby the wiring electrodes of the connector portions 21, 22 of the liquid crystal display panel 3 and the circuit block 4 are connected with the wirings of the heat seal connectors 30b, 30c, which are formed on end portions of the wiring member 30.

Hereinafter, a plurality of embodiments as the wiring member 30 having a twist protecting function will be described.

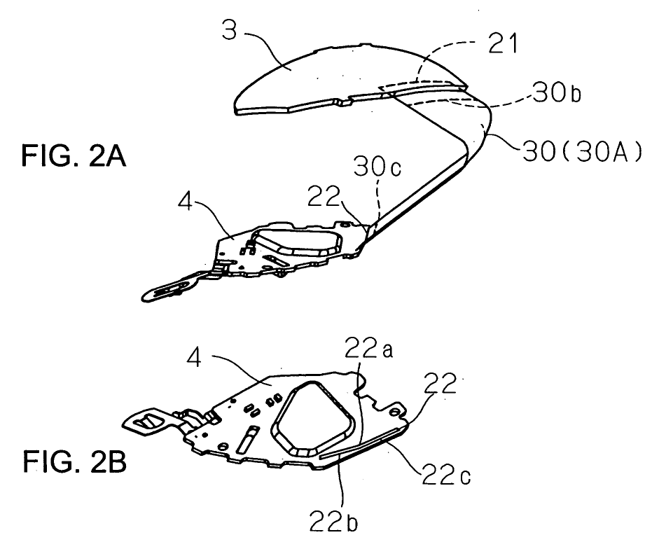

In the wiring member 30A as shown in FIGS. 2A-2B, the end portion of the wiring member 30A on the side of the circuit block 4 is folded in a manner that its section appears as roughly V-like shape or U-like shape, and then connected to the circuit block 4.

As shown in FIG. 2B, on the circuit board 4a of the circuit block 4, the connector portion 22, to which the heat seal connector 30b of the wiring member 30A is connected, has two side portions 22b, 22c, which are angled to each other at a bending portion 22a by a predetermined angle, so that these side portions function as a stress relaxation portion or a twist absorber portion, and thus, on viewing horizontally, these side portions appear as roughly V-like shape.

When the wiring member 30A is to be connected to the connector portion 22 of such a circuit block 4, the heat seal connector 30c is bent into roughly V-like shape correspondingly to the shape of the connector portion 22, and thermally compressed with a heating tool.

In this case, the heat seal connector 30c may be also molded into the same sectional shape as that of the connector portion 22 in advance.

In the above, the heat seal connector 30c of the wiring member 30A on the side to be connected with the circuit block 4 is bent into roughly V-like shape similarly to the connector portion 22, even when the heat seal connector 30b on the side to be connected with the liquid crystal display panel 3 is curved correspondingly to the curved shape of the liquid crystal display panel 3. That makes the entire wiring member 30A bowed and prevents local flexure and stress concentration, and thereby that effects to suppress the occurrence of twisting.

Incidentally, although the connector portion 22 has been described to be bent into roughly V-like shape, its angle may be suitably determined according to the curve etc. on the side of the liquid crystal display panel 3. Moreover, it is also possible to make the connector portion 22 bent into roughly U-like shape instead of V-like shape. However, it is considerable that the efficiency of work can be improved by making the connector portion 22 bent into roughly V-like shape, when the heat seal connector 30c is positioned with the connector portion 22 or when the heating tool is pressed on them, in the heat sealing process, because the two side portions 22b, 22c angled at the bending portion 22a are extending straight.

Thus it becomes possible that the twist of wiring member 30A is suppressed, and that, even when one end of the wiring member 30A is connected to the curved liquid crystal display panel 3, the heat seal connector 30c on the side of another end is easily connected to the connector portion 22 of the circuit block 4.

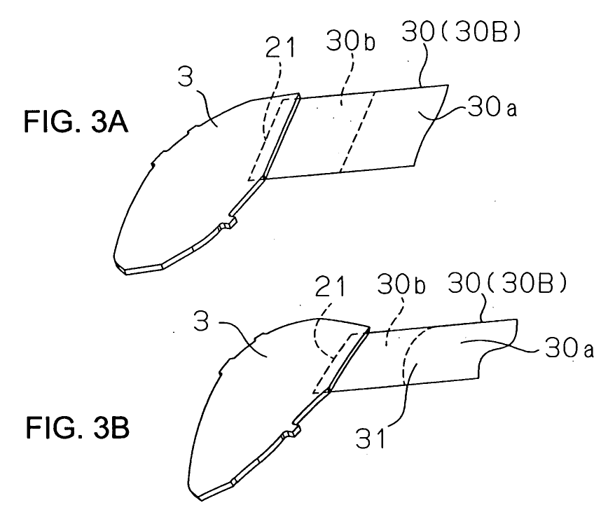

The wiring member 30B shown in FIGS. 3 has a heat seal connector 30b on the side to be connected with the liquid crystal display panel 3, which was originally flat belt-shaped as shown in FIG. 3A but is heated to be deformed curvedly (curled) as shown in FIG. 3B.

For this purpose, one end portion of the wiring member 30B is connected to the circuit block 4, and then, in the heat sealing process for heat-sealing the wiring member 30B to the connector portion 21 of the liquid crystal display panel 3, the heat seal connector 30b of another end portion of the wiring member 30B is heated by applying a hot air (hot blast) to the vicinity of the heat seal connector 30b. As the result, the heat seal connector 30b mainly made of resin material and its peripheral body portion 30a are curled to form a curvedly deformed portion (curved portion, deformed portion) 31. After that, the wiring member 30B, which has been provided with the curvedly deformed portion 31 having the function as the stress relaxation portion or the flexure absorbing portion, is connected to the connector portion 21 of the liquid crystal display panel 3 by heat sealing.

At that time, the direction of curling, when the heat seal connector 30b is heated, is generally determined by the properties etc. of the material composing the heat seal connector 30b and its peripheral body portion 30a, and consequently, the wiring member 30B is preferably made in a manner that the direction of curling coincides with the direction of curve at the connector portion 21 of the liquid crystal display panel 3.

Thus, it becomes possible that the wiring member 30B is easily adapted to the curved direction at the connector portion 21 of the liquid crystal display panel 3, by curling it on the side of the curved liquid crystal display panel 3, and thereby the wiring member 30B can be easily formed into a solid three-dimensional shape, in which the stress is ready to be eased. Consequently, the stress working on the joining portion between the heat seal connector 30b of the wiring member 30B and the connector portion 21 of the liquid crystal display panel 3 can be reduced, and the twist can be suppressed. Furthermore, the connection etc. of the heat seal connector 30b to the connector portion 21 of the curved liquid crystal display panel 3 becomes also easier.

In this connection, it is anticipated that the degree of curling of the wiring member 30B would vary depending on how long time the wiring member 30B has been heated by a heat gun etc., therefore it is desirable to adjust properly the conditions such as heating time, heating temperature, etc., based on the preliminary tests or the like.

Moreover, the timing of heating the wiring member 30B by the heat gun is not limited to the process when the wiring member 30B is heat-sealed on the connector portion 21 of the liquid crystal display panel 3, but it may be also after heat-sealing process, i.e., after the heat seal connector 30b of the wiring member 30B is heat-sealed to the connector portion 21 of the liquid crystal display panel 3.

According to such a configuration, even if a stress is working on the wiring member 30B owing to the connection between the heat seal connector 30b and the connector portion 21 of the curved liquid crystal display panel 3, when the wiring member 30B is heated to thermally deform, the direction of deformation can be readily directed toward such a direction that the stress is relaxed, therefore it produces effectively a twist protecting effect.

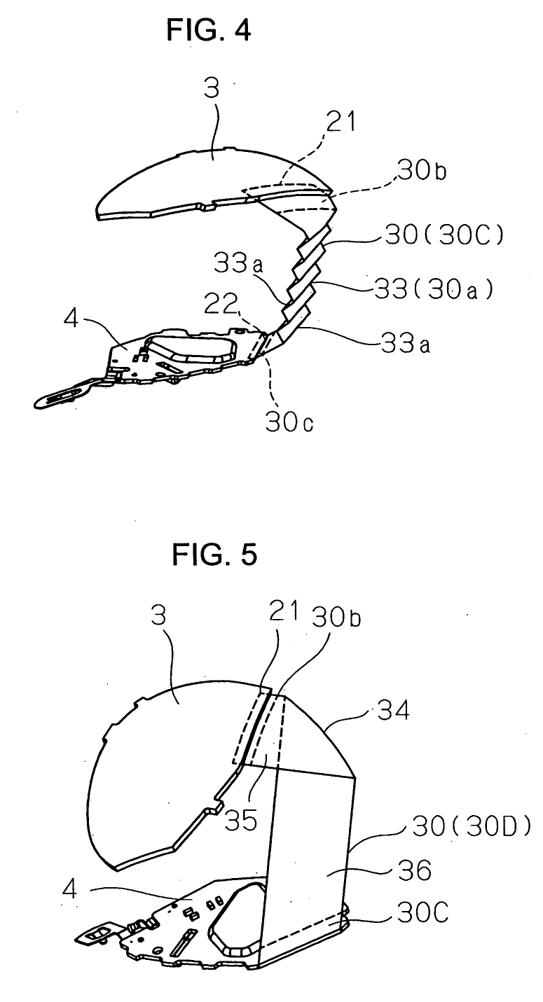

The wiring member 30C shown in FIG. 4 has an accordion portion 33, which has been folded into an accordion-shape and functions as a stress relaxation portion or a flexure absorbing portion. This accordion portion 33 has been formed by folding back alternately the body portion 30a along the lines having a predetermined angle (e.g. 90 degrees) with respect to the direction the wirings extend, i.e., the direction of a line tying one heat seal connector 30b and the other heat seal connector 30c.

Thus a high rigidity is given to the wiring member 30C in the direction its folding lines 33a extend, i.e., the width direction of the wiring member 30C, and thereby the occurrence of twisting can be prevented.

Moreover, with the help of this accordion portion 33, even when the wiring member 30C is bent or folded up, while the both ends of the wiring member are connected to the liquid crystal display panel 3 and the circuit block 4, respectively, various positional deflections can be absorbed by the accordion portion 33, and thereby the stress concentration into a local point can be prevented. Consequently, the efficiency of work when the wiring member 30C is to be bent or folded up is improved, and the risk of broken wires owing to any excessive force applied to the wiring member 30C can be reduced.

In such an accordion portion 33, the direction the folding lines 33a extend is not limited to the above-mentioned 90 degrees, but the angle (direction) of the folding lines 33a can be suitably selected, depending on the direction or the other conditions when the wiring member 30C is to be bent or folded up while the both ends of the wiring member are connected to the liquid crystal display panel 3 and the circuit block 4, respectively, for putting them in the casing 2.

The wiring member 30D shown in FIG. 5 has been bent at its intermediate portion 34, which functions as a stress relaxation portion or a flexure absorbing portion, by a predetermined angle (e.g. 45 degrees) with respect to the direction the wirings extend, i.e., the direction of a line tying one heat seal connector 30b and the other heat seal connector 30c.

According to such a structure, when the one heat seal connector 30b is connected to the curved liquid crystal display panel 3, in response to that, one side 35 is curved in its sectional direction (width direction of the wiring member 30D), so that it describes a curved line, with respect to the intermediate portion 34. Thus, on the one side 35, the section of the wiring member 30D becomes semicylindrical, and thereby becomes more resistant against twisting. Moreover, since the folding direction at the folded part of the intermediate portion 34 is oblique, the radius of curvature in the direction along the folded line of the intermediate portion 34 becomes greater than the radius of curvature in the width direction of the wiring member 30D on the one side 35. Thus, the other side 36 to be connected to the circuit block 4, across the intermediate portion 34, becomes also more resistant against twisting.

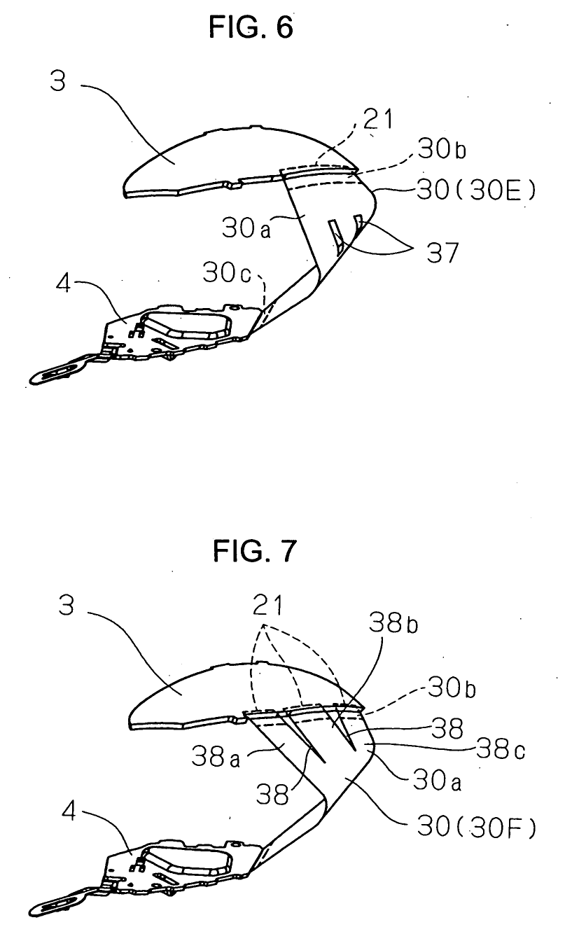

The wiring member 30E shown in FIG. 6 is provided with a number of holes or slits 37, which function as a stress relaxation portion or a flexure absorbing portion, between both heat seal connectors 30b, 30c on the body portion 30a.

Thus, since the wiring member 30E can easily spread, as so-called net could do, to form a curved surface, its flexibility is greatly improved.

According to such a structure, when the heat seal connector 30b of the wiring member 30D is curved to fit to the connector portion 21 of the curved liquid crystal display panel 3, the body portion 30a has a sufficient flexibility to allow the heat seal connector 30b to be easily curved.

Thus the stress working on the connecting part between the heat seal connector 30b of the wiring member 30E and the connector 21 of the liquid crystal display panel 3 can be reduced, and thereby the occurrence of twisting can be suppressed. Moreover, since the wiring member 30E becomes highly flexible, in the case such as when the wiring member 30E is to be curved to fit to the connector portion 21 of the curved liquid crystal display panel 3, the resisting force generated in the wiring member 30E is kept lower, therefore the connecting operation etc. of the wiring member 30E becomes also easier.

Furthermore, even if a stress is working on the wiring member 30E owing to the connection between the heat seal connector 30b and the connector portion 21 of the curved liquid crystal display panel 3, the wiring member 30E is flexible enough to be easily deformed, and, in addition, the direction of deformation becomes such a direction that the stress is relaxed, therefore it produces effectively a twist protecting effect.

The wiring member 30F shown in FIG. 7 is provided with one or more slits 38 having a predetermined length, which function as a stress relaxation portion or a flexure absorbing portion, on the side to be connected to the curved liquid crystal display panel 3.

Thus, on the side to be connected to the curved liquid crystal display panel 3, the heat seal connector 30b and the body portion 30a of the wiring member 30F are divided into a plurality of belt-shaped parts 38a, 38b, 38c, and that with each part reduced in its width.

In the wiring member 30F, since respective belt-shaped parts 38a, 38b, 38c have smaller width, even if they are curved as a whole to fit to the liquid crystal display panel 3, stress working on each belt-shaped part 38a, 38b, 38c becomes smaller, and thereby the risk of twisting will be reduced. Moreover, the connector portion 21 on the side of the liquid crystal display panel 3 maybe divided into a plurality of parts, correspondingly to a plurality of belt-shaped parts 38a, 38b, 38c, as well. According to such a structure, it is also possible to form each of divided parts of connector portion 21 linearly, therefore there is also room for improvement in efficiency of work.

Furthermore, in the above-described wiring member 30F, each length of the belt-shaped parts 38a, 38b, 38c maybe selected differently.

In this case, it becomes unnecessary to arrange the connector portion 21 of the liquid crystal display panel 3 side on one straight line, therefore the degree of freedom in design can be increased.

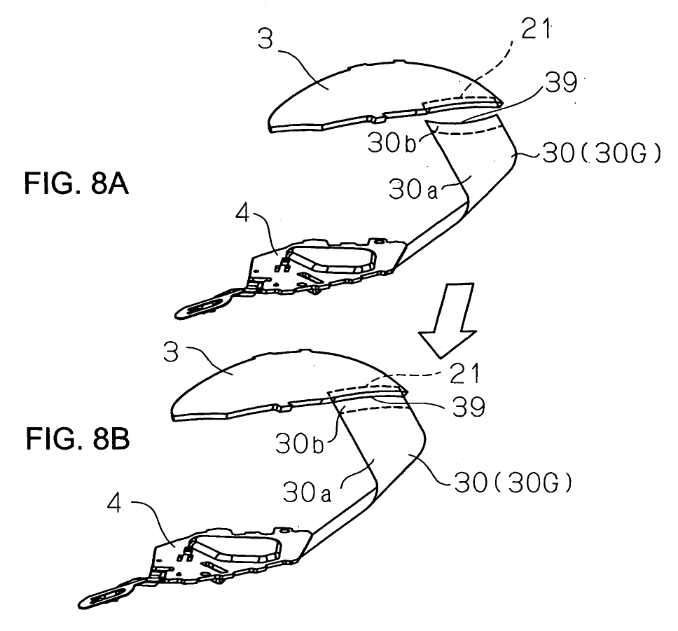

In the wiring member 30G shown in FIGS. 8A-8B, an end portion 39 of one heat seal connector 30b is shaped, as shown in FIG. 8A, such that it is curved to fit to the connector portion 21 of the curved liquid crystal display panel 3, with its center portion recessed for functioning as a stress relaxation portion or a flexure absorbing portion.

In such a wiring member 30G, the side of a heat seal connector 30b of the wiring member 30G can be easily shaped semicylindrical, as shown in FIG. 8B, by fitting the end portion 39 of the heat seal connector 30b to the connector portion 21 of the curved liquid crystal display panel 3. Therefore, the occurrence of twisting in the wiring member 30G can be prevented effectively.

According to above-described wiring members 30A-30G, since those wiring members 30A-30G have the twist protecting function, even when they are folded and received into the casing 2, while one end thereof being connected to the curved liquid crystal display panel 3, the local flexure or the stress concentration can be reduced and thereby twisting can be prevented from occurring. Consequently, the stress that would be concentrated to the connecting part between the wiring member 30A-30G and the liquid crystal display panel 3 can be reduced, therefore the connection failure etc. can be prevented from occurring. Furthermore, by employing the structure resulting such an effect, it becomes also possible to increase the number of terminals to be connected with one of the wiring members 30A-30G, than ever.

Besides, since the occurrence of twisting in the wiring members 30A-30G can be prevented, those wiring members can be easily folded when those wiring members are to be folded and received in the opening portion 10 of the casing 2, after connecting them to the liquid crystal display panel 3 and the circuit block 4. As the result, the efficiency of work is improved, and the production efficiency can be raised. Especially, in the case of the wiring members 30C, 30E, in which it is formed into accordion-shape or net-shape, since the flexibility. (allowance) for bending can be higher, the effect is further remarkable.

Further according to the wiring members 30F, 30G, in which the structure for connecting to the connector portion 21 of the curved liquid crystal display panel 3 has been devised, when such a wiring member is connected to the curved liquid crystal display panel 3, the operations such as positioning, fixing and heat-sealing can be easily carried out, therefore the efficiency of work can be improved and the risk to produce defects can be reduced.

Additionally, although, in the above-exemplified embodiments, the heat seal connectors 30b, 30c of the wiring member 30 made of PCB were described to have been integrally welded with the body portion 30a in advance, but originally prepared separately as individual parts, the entire wiring member 30 may be also formed of a heat seal material.

Moreover, in the case of the wiring member 30B, although it was described to be heated for curving in or after the process for connecting it to the liquid crystal display panel 3, it should not be limited to that procedure, but the entire wiring member 30 may be also molded into a three-dimensional shape in advance.

In addition to that, it is useful, of course, to suitably select and combine the wiring members out of e.g. the wiring members 30B, 30F, 30G, etc., in which the part of the wiring member 30 to be connected to the liquid crystal display panel 3 side has been devised; the wiring members 30C, 30D, 30E, etc., in which the body portion 30a of the intermediate portion has been devised; and the wiring members 30A etc., in which the part to be connected to the circuit block 4 side has been devised.

Besides, although, in the structure shown in FIG. 1, the entire structure of a wristwatch 20 was specifically described, the part not concerned with the essence of the present invention may be replaced by any other structure. For example, it may be also configured so that, not only the liquid crystal display panel 3, but the circuit block 4 may be curved as well. Moreover, the present invention can be usefully applied to the case where the liquid crystal display panel 3 is planar while the circuit block 4 is curved.

Furthermore, as far as at least one curved circuit board is employed, the present invention can be applied not only to the digital wristwatch 20 but also to analog watch etc., and to the PDA (Personal Digital Assistant) and other various electronic devices. Such electronic devices may, of course, assume various forms other than wristwatch.

In addition to those, within the scope of spirit of the present invention, the structure may be properly selected out of those in the above embodiments or suitably modified into the other structures.

As described heretofore, according to the present invention, when two substrates laminated vertically, wherein at least one of two substrates is curved, are to be connected with a belt-shaped wiring member having flexibility, the occurrence of twisting etc. in the wiring member can be prevented by easing a stress in a stress relaxation portion, and the stress generated at a portion of the wiring member connected to the substrate can be also eased. As the result, the connection failure such as broken wires owing to the occurrence of twisting can be prevented, and thereby the reliability of the electronic devices can be improved. Furthermore, various efficiencies of work such as, in assembling processes, positioning, fixing, heat-sealing, putting into the casing, etc. can be improved.

In order to form such a stress relaxation portion, the wiring member may be e.g. heated to thermally deform, so that the wiring member is formed in to a solid three-dimensional shape, by which the stress can be eased.

Moreover, in the electronic device according to the present invention, which is suitable for watch etc., a three-dimensionally shaped display cover is mounted on the opening portion of the case receiving the circuit block and the display panel. In such a structure, the occurrence of twisting etc. in the wiring member can be suppressed, by absorbing the flexure by a flexure absorbing portion, the flexure being caused from that the wiring member is connected to the curved liquid crystal display panel by heat-sealing or other methods. As the result, the connection failure etc. can be prevented from occurring, and thereby the reliability of the electronic devices can be improved. Furthermore, the efficiency of work in assembling process can be improved.

Additionally, according to the present invention, when an electronic device is assembled by connecting a planar first circuit panel to a curved second circuit panel with a wiring member, the stress working on the wiring member when it is connected to the curved second circuit panel can be eased, by heating the wiring member at another end portion to curvedly deform it. As the result, the connection failure between the wiring member and the circuit panel is prevented from occurring, and thereby the reliability of the electronic devices assembled can be improved. Furthermore, the efficiency of work in assembling process can be improved.

What is claimed is:

1. An electronic device comprising:
two substrates laminated vertically, at least one of which being curved;
a belt-shaped wiring member having flexibility, for connecting electrically the two substrates; and
a stress relaxation portion for easing a stress, which works on the wiring member by a connection between the wiring member and the substrate having a curved shape.

2. An electronic device as defined in claim 1,
wherein a connector having a bent-shape or curved-shape is formed as the stress relaxation portion on one of the substrates,
and wherein the wiring member is connected in a bent or curved manner correspondingly to the bent-shape or curved-shape of the connector.

3. An electronic device as defined in claim 1,
wherein the belt-shaped wiring member is provided with a deformed portion as the stress relaxation portion, the deformed portion being curved toward such a direction that the stress, which works on the wiring member, can be eased.

4. An electronic device as defined in claim 2,
wherein the belt-shaped wiring member is provided with a deformed portion as the stress relaxation portion, the deformed portion being curved toward such a direction that the stress, which works on the wiring member, can be eased.

5. An electronic device having a display unit that is curved in a three-dimensional shape, comprising:
a display panel that composes the display unit and is curved;
a panel-shaped circuit block that controls the display panel;
a casing that receives the display panel and the circuit block, and forms an outer shell of the electronic device;
a belt-shaped wiring member that connects electrically the display panel with the circuit block in the casing, an intermediate portion of the wiring member being folded back in the casing; and
a flexure absorbing portion that absorbs a flexure generated in the wiring member by a connection between the wiring member and a curved part of the display panel.

6. An electronic device as defined in claim 5,
where in the wiring member is provided with a curved portion as the flexure absorbing portion, the curved portion being curved substantially spherically out of a surface of the wiring member.

7. An electronic device as defined in claim 5,
wherein the wiring member is connected to the display panel and the circuit block by heat sealing.

8. An electronic device as defined in claim 6,
wherein the wiring member is connected to the display panel and the circuit block by heat sealing.

9. An electronic device as defined in claims 5,
wherein the electronic device is a watch, and wherein the casing has an opening on the display unit side and a closed bottom, and, under a condition that the circuit block and the display panel are contained in the casing, a three-dimensional display cover is mounted on the opening of the casing.

10. An electronic device as defined in claims 6,
wherein the electronic device is a watch, and wherein the casing has an opening on the display unit side and a closed bottom, and, under a condition that the circuit block and the display panel are contained in the casing, a three-dimensional display cover is mounted on the opening of the casing.

11. The electronic device as defined in claims 7,
wherein the electronic device is a watch, and wherein the casing has an opening on the display unit side and a closed bottom, and, under a condition that the circuit block and the display panel are contained in the casing, a three-dimensional display cover is mounted on the opening of the casing.

12. An electronic device as defined in claims 8,
wherein the electronic device is a watch, and wherein the casing has an opening on the display unit side and a closed bottom, and, under a condition that the circuit block and the display panel are contained in the casing, a three-dimensional display cover is mounted on the opening of the casing.

13. A method of assembling an electronic device, which has a planar first circuit panel and a curved second circuit panel, comprising steps of:
connecting an end of a belt-shaped wiring member to the first circuit panel;
heating the wiring member to curvedly deform another end portion of the wiring member; and
connecting the another end of the wiring member to the second circuit panel.
